(19) United States
(12) Patent Application Publication
(10) Pub. No.: US 2018/0376370 A1
(43) Pub. Date: Dec. 27, 2018

(54) WAKEUP PACKET PREAMBLE

(71) Applicant: QUALCOMM Incorporated, San Diego, CA (US)

(72) Inventors: Stephen Jay SHELLHAMMER, Ramona, CA (US); Bin TIAN, San Diego, CA (US)

(21) Appl. No.: 16/009,849

(22) Filed: Jun. 15, 2018

Related U.S. Application Data
(60) Provisional application No. 62/525,069, filed on Jun. 26, 2017.

(51) Int. Cl. H04W 28/06; H04W 52/02; H04L 27/02; H04L 27/26

(52) U.S. Cl. CPC H04W 28/065; H04L 27/2601; H04L 27/02; H04W 52/0229

(57) ABSTRACT

A method of operation of an electronic device includes receiving a preamble portion of a packet from an access point using a wakeup receiver of the electronic device and receiving a data portion of the packet from the access point using the wakeup receiver. The preamble portion includes a preamble bit having a preamble bit duration, and the data portion includes a data bit having a data bit duration that is longer than the preamble bit duration.

### I. CROSS REFERENCE TO RELATED APPLICATIONS

The present application claims priority from U.S. Provisional Patent Application No. 62/525,069 entitled “WAKEUP PACKET PREAMBLE,” filed Jun. 26, 2017, which is incorporated herein by reference in its entirety.

### II. FIELD

The present disclosure is generally related to electronic devices and more particularly to access point wakeup of electronic devices.

### III. DESCRIPTION OF RELATED ART

Stations (e.g., wireless telephones, laptop computers, Internet of Things (IoT) devices, etc.) in a wireless network may operate in different power modes. For example, a station may operate in an Institute of Electrical and Electronics Engineers (IEEE) 802.11 (e.g., “Wi-Fi”) wireless network in an “awake” mode (e.g., a fully powered mode of operation) and in a “sleep” mode. During operation in the awake mode, the station may transmit data to (and receive data from) an access point in the IEEE 802.11 wireless network. During operation in the sleep mode, the radio frequency capabilities of the station are typically significantly reduced to conserve power, and the station may not able to transmit data to (or receive data from) the access point.

During operation in the sleep mode, a wakeup receiver of the station may activate to determine if a message is received from the access point. For example, the wakeup receiver may be an ultra-low-power receiver that determines whether an activation message has been received from the access point. If an activation message is detected and decoded with a wakeup message, the station may transition from the sleep mode to the awake mode and may initiate communication via the main Wi-Fi network with the access point.

The wakeup receiver may tune to a wakeup channel and may compare a signal received via the wakeup channel to a message preamble to detect whether a message is received. For example, the preamble may include a specific sequence of bits that is recognizable by the wakeup receiver, even in the presence of some amount of noise in the wakeup channel. The wakeup receiver may also use the message preamble for symbol timing correction (e.g., to adjust a sampling clock of the wakeup receiver) and to identify the beginning of a data portion or “payload” of the message. Increasing the length of the message preamble enables the wakeup receiver to detect messages and correct symbol timing with higher accuracy as compared to using a shorter message preamble. Thus, increasing the length of the message preamble results in greater reliability that the station wakes from the sleep mode when signaled by the access device. However, because the preamble may be considered “overhead,” e.g., radio resources that are consumed but that do not convey payload data, increasing the length of the message preamble reduces the efficiency of communication via the wakeup channel and increases the power consumption of the wakeup receiver.

### IV. SUMMARY

An electronic device in accordance with the disclosure is configured to receive a message (e.g., a beacon) from an access point using a wakeup receiver. The message (also referred to as a “packet”) includes a preamble portion and a data portion. Bits in the preamble portion are received at a higher bit rate than bits in the data portion, and thus the bits in the preamble portion have a lower bit duration (e.g., a length of time that a bit is transmitted on the wakeup channel) than the bits in the data portion. As a result, the preamble may have a relatively short transmission duration as compared to the data portion, for enhanced power efficiency, while also including a relatively long bit sequence to enable enhanced message detection and symbol timing correction.

In an illustrative example, a method of operation of an electronic device includes receiving a preamble portion of a packet from an access point using a wakeup receiver of the electronic device. The preamble portion includes a preamble bit having a preamble bit duration. The method also includes receiving a data portion of the packet from the access point using the wakeup receiver. The data portion includes a data bit having a data bit duration that is longer than the preamble bit duration.

In another illustrative example, a method of operation of an electronic device includes receiving a preamble portion of a packet from an access point using a wakeup receiver of the electronic device. The preamble portion includes a bit sequence represented by on-off keying modulation of an orthogonal frequency division multiplexing (OFDM) waveform. The bit sequence includes at least one of an alternating bit pattern or a maximum length sequence. The method also includes receiving a data portion of the packet from the access point using the wakeup receiver.

In another illustrative example, an electronic device includes a wakeup receiver configured to receive a preamble portion and a data portion of a packet from an access point via a first channel. The preamble portion includes a preamble bit having a preamble bit duration and the data portion including a data bit having a data bit duration that is longer than the preamble bit duration. The electronic device also includes a modem configured to communicate with the access point using a second channel.

In another illustrative example, the electronic device includes a wakeup receiver configured to receive a preamble portion and a data portion of a packet from an access point via a first channel. The preamble portion includes a bit sequence represented by on-off keying modulation of an orthogonal frequency division multiplexing (OFDM) waveform. The bit sequence includes at least one of an alternating bit pattern or a maximum length sequence. The electronic device also includes a modem configured to communicate with the access point using a second channel.

In another illustrative example, a method of operation of an access point includes transmitting, using a transmitter of the access point, a preamble portion of a packet to an electronic device. The preamble portion includes a preamble bit having a preamble bit duration. The method also includes transmitting, using the transmitter, a data portion of the packet to the electronic device. The data portion includes a data bit having a data bit duration that is longer than the preamble bit duration.

In another illustrative example, a method of operation of an access point includes transmitting, using a transmitter of the access point, a preamble portion of a packet to an electronic device. The preamble portion includes a bit sequence represented by on-off keying modulation of an orthogonal frequency division multiplexing (OFDM) waveform. The bit sequence includes at least one of an alternating bit pattern or a maximum length sequence. The method also includes transmitting, using the transmitter, a data portion of the packet to the electronic device.

In another illustrative example, an apparatus includes a transmitter configured to transmit a preamble portion and a data portion of a packet to an electronic device via a first channel. The preamble portion includes a preamble bit having a preamble bit duration and the data portion including a data bit having a data bit duration that is longer than the preamble bit duration. The apparatus also includes a modem configured to communicate with the electronic device using a second channel.

In another illustrative example, an apparatus includes a transmitter configured to transmit a preamble portion and a data portion of a packet to an electronic device. The preamble portion includes a bit sequence represented by on-off keying modulation of an orthogonal frequency division multiplexing (OFDM) waveform. The bit sequence includes at least one of an alternating bit pattern or a maximum length sequence. The apparatus also includes a modem configured to communicate with the electronic device using a second channel.

One particular advantage provided by at least one of the disclosed examples is reduced power consumption by an electronic device. For example, use of a packet preamble having a longer bit sequence with a shorter bit duration reduces total packet length (e.g., transmission duration), and therefore reduces receiver power consumption, as compared to a packet preamble having the longer bit sequence with a longer bit duration. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of an illustrative example of a system that includes an access point configured to send a message using a wakeup transmitter and an electronic device configured to receive the message using a wakeup receiver.

FIG. 2 is a diagram of an illustrative example of a wakeup radio (WUR) message format that may be associated with the message of FIG. 1 and examples of preamble and data bit durations.

FIG. 3 is a diagram of an illustrative example of components that may be used in the system of FIG. 1.

FIG. 4 is a flow chart of an example of a method of operation of an electronic device, such as the electronic device of FIG. 1.

FIG. 5 is a flow chart of another example of a method of operation of an electronic device, such as the electronic device of FIG. 1.

FIG. 6 is a flow chart of another example of a method of operation of an electronic device, such as the electronic device of FIG. 1.

FIG. 7 is a flow chart of another example of a method of operation of an electronic device, such as the electronic device of FIG. 1.

FIG. 8 is a flow chart of an example of a method of operation of an apparatus, such as the access point of FIG. 1.

FIG. 9 is a flow chart of another example of a method of operation of an apparatus, such as the access point of FIG. 1.

FIG. 10 is a flow chart of another example of a method of operation of an apparatus, such as the access point of FIG. 1.

FIG. 11 is a flow chart of another example of a method of operation of an apparatus, such as the access point of FIG. 1.

FIG. 12 is a block diagram of an illustrative example of an electronic device, such as the electronic device of FIG. 1.

### VI. DETAILED DESCRIPTION

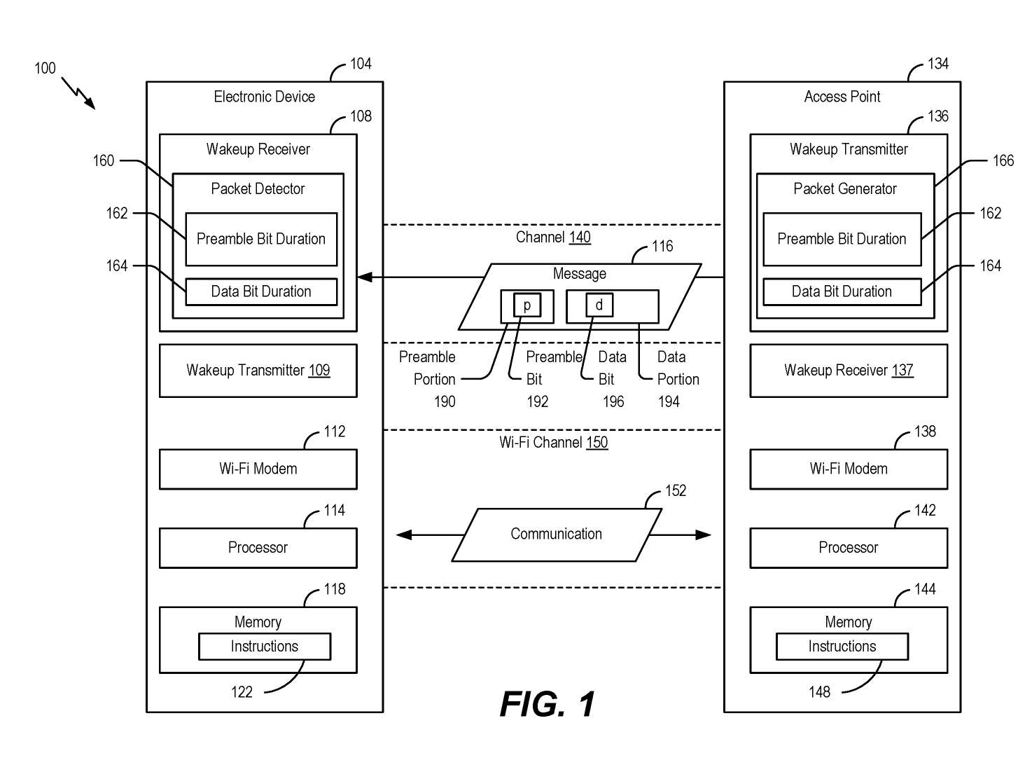

FIG. 1 depicts an illustrative example of a system 100 that includes an electronic device 104 and an access point 134. The electronic device 104 may correspond to a station (STA), such as a mobile device, as an illustrative example. The electronic device 104 is configured to detect a message 116 from the access point 134. The message 116 includes preamble bits in a preamble portion 190 that have a first bit duration and data bits in a data portion 194 that have a second bit duration that is longer than the first bit duration.

The electronic device 104 includes a receiver, such as a wakeup receiver 108, and a radio device configured to operate based on an Institute of Electrical and Electronics Engineers (IEEE) 802.11 (“Wi-Fi”) communication protocol. For example, the radio device may include a modem, such as a Wi-Fi modem 112. The wakeup receiver 108 may be configured to operate in accordance with a particular IEEE 802.11 communication protocol, such as an IEEE 802.11ba communication protocol. The wakeup receiver 108 is configured to receive messages (e.g., from an access point, such as the access point 134) using a first power consumption that is less than a second power consumption used by the Wi-Fi modem 112 to receive messages. For example, the wakeup receiver 108 may have a narrowband configuration. In this case, the wakeup receiver 108 is configured to receive messages using a frequency band having a first bandwidth that is less than a second bandwidth of a frequency band used by the Wi-Fi modem 112 to receive messages. To illustrate, in a particular implementation the Wi-Fi modem 112 is configured to receive data transmitted via a modulation of a waveform of an orthogonal frequency division multiplexing (OFDM) scheme that uses a first number of carriers, and the wakeup receiver 108 is configured to receive data transmitted via modulation of an OFDM waveform that uses a second number of carriers that is smaller than the first number of carriers.

Receiving messages using the first bandwidth may result in reduced power consumption by the electronic device 104 as compared to receiving messages using the second bandwidth. To illustrate, signals transmitted using the first bandwidth may be associated with reduced noise (e.g., reduced thermal noise) as compared to signals transmitted using the second bandwidth, resulting in increased signal-to-noise ratios (SNRs) of the signals transmitted using the first bandwidth. Increased SNRs may enable reduced amplification to send and receive the signals, reducing power consumption by the electronic device 104.

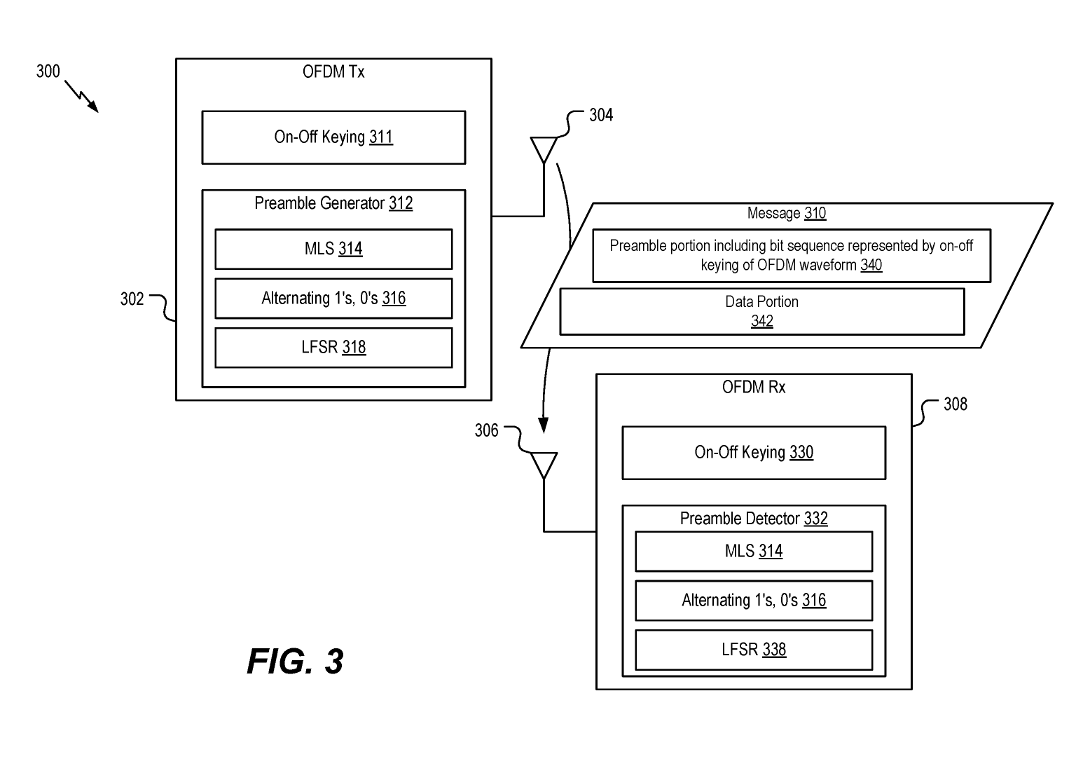

The wakeup receiver 108 includes a packet detector 160 that is configured to detect the message 116 via detection of the preamble portion 190. The preamble portion 190 may also be referred to as a synchronization (Sync) field. The packet detector 160 is configured to sample a signal received at the channel 140 to determine whether the sampled signal represents the preamble portion 190. In a particular implementation, the packet detector 160 generates a sampled signal by sampling the channel 140 at periodic intervals and determines a cross-correlation value of the sampled signal with a preamble bit sequence that is stored in the packet detector 160. The packet detector 160 compares the cross-correlation value to a threshold and determines that a preamble is detected in response to the cross-correlation value exceeding the threshold. Examples of preamble bit sequences are described in further detail with reference to FIG. 3.

The packet detector 160 includes data indicating a preamble bit duration 162 and a data bit duration 164. The preamble bit duration 162 corresponds to a first length of time between beginnings (or mid-points, endings, etc.) of successively received preamble bits in the preamble portion 190, such as a representative preamble bit 192. The data bit duration 164 corresponds to a second length of time between beginnings (or mid-points, endings, etc.) of successively received data bits in the data portion 194. The packet detector 160 is configured to determine a sampling rate for preamble detection based on the preamble bit duration 162. For example, in an example where the preamble bit duration 162 is 2 microseconds (μs), the packet detector 160 samples the channel 140 at 2 μs intervals to generate the sampled signal for cross-correlation.

In addition to detecting the preamble portion 190 via matching a bit sequence, the packet detector 160 is configured to perform symbol timing correction based on the preamble portion 190. In an implementation where the wakeup receiver 108 is a non-coherent receiver, symbol clock and phase information of symbols in the message 116 are extracted from the preamble portion 190 of the message. For example, the packet detector 160 may vary a sampling phase to align a sampling clock with the midpoint of each bit, by selecting a sampling phase that results in a largest cross-correlation value as compared to the cross-correlation values resulting from sampling the preamble portion 190 using other sampling phases.

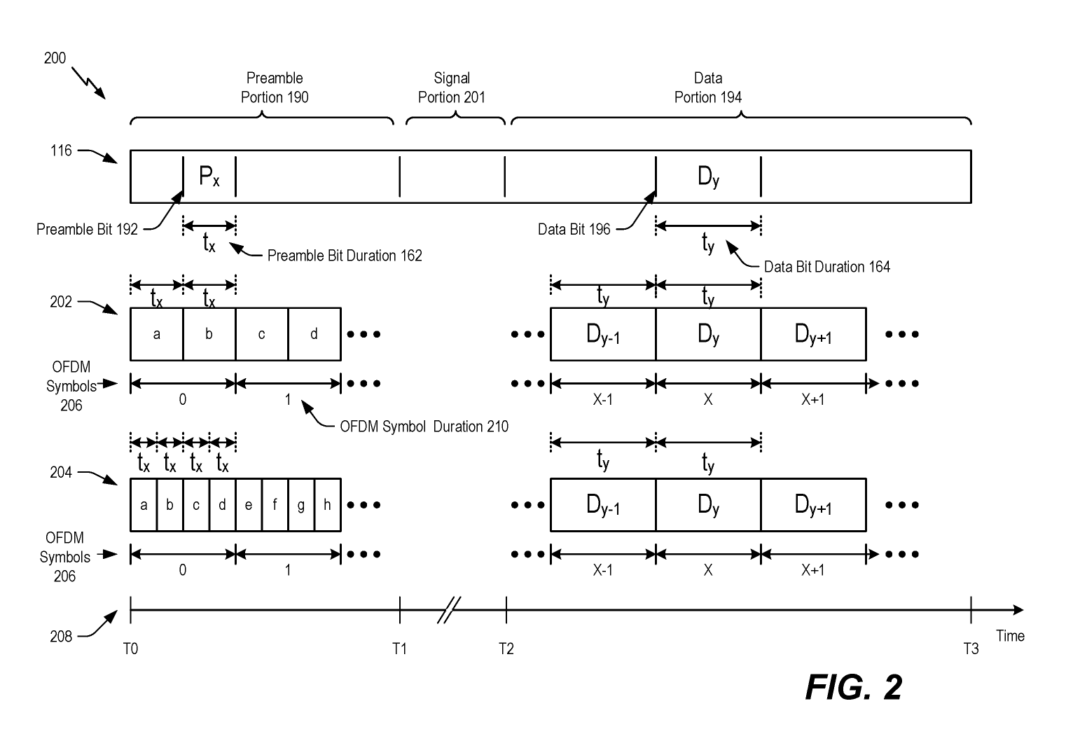

After the preamble portion 190 of the message 116 is detected via sampling using the preamble bit duration 162, the packet detector 160 samples the channel 140 at a slower sampling rate based on the data bit duration 164 to receive the data bits of the data portion 194. Examples of timing for transmission or receipt of the preamble portion 190 and the data portion 194 are described in further detail with reference to FIG. 2.

The electronic device 104 further includes a processor 114 and a memory 118. The memory 118 stores instructions 122. The processor 114 is coupled to the memory 118 and is configured to access the instructions 122. The processor 114 is configured to execute the instructions 122 to initiate, control, or perform one or more operations described herein.

In some implementations, the electronic device 104 includes a transmitter, such as a wakeup transmitter 109, that is configured to transmit messages via the channel 140 to the access point 134. The wakeup transmitter 109 may operate in a similar manner as described below with reference to the wakeup transmitter 136 of the access point 134, and messages transmitted by the wakeup transmitter 109 may have similar characteristics and use a similar format as described with reference to the message 116. The wakeup transmitter 109 may operate in accordance with an IEEE 802.11ba communication protocol. In other implementations, the electronic device 104 does not include the wakeup transmitter 109 and instead uses the Wi-Fi channel 150 to send messages to the access point 134.

The access point 134 includes a transmitter, such as a wakeup transmitter 136, and a modem, such as a Wi-Fi modem 138. The wakeup transmitter 136 may be configured to send messages (e.g., to an electronic device, such as the electronic device 104) using a first power consumption that is less than a second power consumption used by the Wi-Fi modem 138 to send messages. For example, the wakeup transmitter 136 may have a narrowband configuration. In this case, the wakeup transmitter 136 may be configured to send messages using the frequency band having the first bandwidth that is less than the second bandwidth of the frequency band used by the Wi-Fi modem 138 to send messages. The wakeup transmitter 136 may operate in accordance with an IEEE 802.11ba communication protocol.

The wakeup transmitter 136 includes a packet generator 166 that is configured to receive data to be transmitted (e.g., a beacon from a network management application executing at the processor 142) and to generate packets of the data for transmission over the channel 140, such as via the message 116. For example, the message 116 may include information such as an address or identifier of the electronic device 104, an instruction or command to be executed by the electronic device 104, a status or other indication, or other information. The packet generator 166 is configured to include the preamble portion 190 using preamble bits having the preamble bit duration 162 into packets that also include data bits having the data bit duration 164 when transmitted via the channel 140.

The access point 134 further includes a processor 142 and a memory 144. The memory 144 stores instructions 148. The processor 142 is coupled to the memory 144 and is configured to access the instructions 148. The processor 142 is configured to execute the instructions 148 to initiate, control, or perform one or more operations described herein.

In some implementations, the access point 134 includes a receiver, such as a wakeup receiver 137, that is configured to receive messages via the channel 140 from the electronic device 104. The wakeup receiver 137 may operate in a similar manner as described the wakeup receiver 108 of the electronic device 104, and messages received by the wakeup receiver 137 may have similar characteristics and use a similar format as described with reference to the message 116. The wakeup receiver 137 may operate in accordance with an IEEE 802.11ba communication protocol. In other implementations, the access point 134 does not include the wakeup receiver 137 and instead uses the Wi-Fi channel 150 to receive messages from the electronic device 104.

One or more of the wakeup receiver 108, the Wi-Fi modem 112, the wakeup transmitter 136, and the Wi-Fi modem 138 may be configured to operate using one or more wireless communication protocols. As an illustrative example, one or more of the wakeup receiver 108, the Wi-Fi modem 112, the wakeup transmitter 136, and the Wi-Fi modem 138 may be configured to operate in compliance with one or more IEEE 802.11 wireless communication protocols.

During operation, the access point 134 may send the message 116 (e.g., a beacon) using the wakeup transmitter 136. In an illustrative example, the access point 134 is configured to send the message 116 using a first channel 140. The channel 140 may be associated with a particular wireless communication protocol (e.g., an IEEE 802.11 wireless communication protocol, as an illustrative example).

The electronic device 104 may perform a scanning process to detect one or more access points within communication range of the electronic device 104. In some cases, the Wi-Fi modem 112 may operate according to a sleep mode of operation during the scanning process (e.g., if the electronic device 104 is not associated with an access point).

During the scanning process, the electronic device 104 may receive the message 116 from the access point 134 using the wakeup receiver 108. In some cases, the electronic device 104 may deactivate the Wi-Fi modem 112 prior to receiving the message 116 (e.g., the electronic device 104 may receive the message 116 while the Wi-Fi modem 112 operates according to a standby mode of operation).

The packet detector 160 samples a signal received via the channel 140 (e.g., the received signal may include noise only, a transmitted message, or a combination of noise and a transmitted message) at a sample rate that is based on the preamble bit duration 162. The packet detector 160 compares sequences of the samples to one or more particular preamble bit sequences to detect receipt the preamble portion 190 of the message 116. In response to detecting the preamble portion 190, the packet detector 160 performs symbol timing correction using the preamble portion 190.

The electronic device 104 is configured to activate the Wi-Fi modem 112 in response to receiving the message 116. To illustrate, in response to receiving the message 116, the electronic device 104 may provide an activation signal to the Wi-Fi modem 112 to activate the Wi-Fi modem 112 (e.g., to switch operation of the Wi-Fi modem 112 from a sleep mode to an active mode). In some implementations, the electronic device 104 may include a switch configured to receive a supply voltage that powers the Wi-Fi modem 112, and the electronic device 104 may power-up the Wi-Fi modem 112 by activating the switch in response to the message 116.

After activating the Wi-Fi modem 112, the electronic device 104 is configured to communicate with the access point 134 using the Wi-Fi modem 112. For example, the electronic device 104 perform an association process with the access point 134 after activating the Wi-Fi modem 112. Performing the association process may include sending and receiving one or more association messages using a second channel, such as a Wi-Fi channel 150, that is included in a Wi-Fi network used by the access point 134 to communicate with the electronic device 104. The Wi-Fi channel 150 is distinct from the channel 140. As an illustrative example, the electronic device 104 may send a communication 152 (e.g., an association request) to the access point 134 based on the message 116. The communication 152 may be received by the access point 134 using the Wi-Fi channel 150.

One or more aspects of FIG. 1 may improve performance of a device, such as the electronic device 104. For example, because the preamble portion 190 of the message 116 uses the preamble bit duration 162 to transmit preamble bits, the preamble bits are transmitted in a shorter time as compared to an implementation that uses the data bit duration 164 to transmit the preamble bits. As a result, overhead associated with sending and receiving the message 116 is reduced, and power consumed by the electronic device 104 and the access point 134 may also be reduced.

FIG. 2 depicts an illustrative example of a wakeup radio (WUR) message format 200 that may be associated with the message 116 of FIG. 1. The WUR message format 200 includes the preamble portion 190, also referred to as the Sync field, and the data portion 194. In some implementations, the WUR message format 200 also includes a signal portion 201 that may include information indicative of a length of the data portion 194 (e.g., a number of bits or symbols in the data portion 194) and a data rate of the data portion 194 (e.g., an indication of the data bit duration 164). The signal portion 201 is optional, and in some implementations, the signal portion 201 is not included.

The preamble portion 190 includes the representative preamble bit 192. The preamble bit 192 is illustrated as an x-th bit Pₓ of the preamble portion 190 and has the preamble bit duration (tₓ) 162. The data portion 194 includes the representative data bit 196. The data bit 196 is illustrated as a y-th bit D_{y} of the data portion 194 and has the data bit duration (t_{y}) 164. Although elements depicted in FIGS. 1-12 are not necessarily drawn to scale, a first example 202 and a second example 204 depicts relative durations of representative preamble bits and data bits as lengths along a time axis 208. As illustrated, the message 116 begins at a time TO along the time axis 208, the signal portion 201 begins at time T1, the data portion 194 begins at time T2, and the message 116 ends at time T3.

In the first example 202, the data bit duration (t_{y}) 164 is substantially equal to twice the preamble bit duration (tₓ) 162. Representative data bits D_{y-1}, D_{y}, and D_{y+1}, are aligned to symbol boundaries of OFDM symbols 206 of an OFDM transmission scheme. In a particular implementation, the message 116 may be transmitted by the access point 134 and received at the wakeup receiver 108 via an orthogonal frequency-division multiplexing (OFDM) signal, the OFDM signal including the symbols 206, each having a symbol duration 210. The symbols may be generated via an on-off keying modulation scheme, as described further with reference to FIG. 3.

The symbol duration 210 and the data bit duration 164 are each substantially equal to an integer multiple of the preamble bit duration 162. As illustrated in the first example 202, a sequence of representative preamble bits a, b, c, d are transmitted at substantially double the OFDM symbol rate (e.g., the symbol duration 210 is substantially two times the preamble bit duration (tₓ) 162). In the second example 204, a sequence of representative preamble bits a, b, c, d, e, f, g, h are transmitted at substantially four times the OFDM symbol rate (e.g., the data bit duration (t_{y}) 164 and the symbol duration 210 are each substantially equal to four times the preamble bit duration (tₓ) 162).

Although FIG. 2 depicts illustrative examples of format and timing of the message 116, in other implementations the message 116 may differ from the examples of FIG. 2. For example, the data bit duration 164 may be less than the symbol duration 210 (e.g., two data bits per OFDM symbol), or may be greater than the symbol duration 210 (e.g., a Manchester encoding may be used that results in each data bit being transmitted using two OFDM symbols to encode each data bit as a 0-to-1 or 1-to-0 symbol transition). Although the message 116 is depicted as beginning with the preamble portion 190, in other implementations a “legacy’ portion of the message 116 may precede the preamble portion 190. The legacy portion may include a broadband message for compatibility with devices in the wireless network that do not support communication via the channel 140. The legacy portion may include an instruction for such non-compatible devices to avoid transmission on the wireless network for the duration of the message 116.

FIG. 3 depicts an example of a system 300 that includes an OFDM transmitter 302 configured to transmit a message 310 to an OFDM receiver 308. In a particular implementation, the OFDM transmitter 302 corresponds to the wakeup transmitter 136, the OFDM receiver 308 corresponds to the wakeup receiver 108, and the message 310 corresponds to the message 116 of FIG. 1. The OFDM transmitter 302 and the OFDM receiver 308 may operate in accordance with an IEEE 802.11ba communication protocol.

The OFDM transmitter 302 includes an on-off keying circuit 311 and a preamble generator 312. The on-off keying circuit 311 is configured to modulate an ODFM waveform via on-off keying (e.g., multiplying the waveform by “1” to transmit a first value or by “0” to transmit a second value). Modulating an OFDM waveform via on-off keying may also be referred to as performing multicarrier on-off keying.

The preamble generator 312 is configured to generate a preamble portion 340 of the message 310. The preamble portion 340 may also be referred to as the Sync field. The preamble portion 340 includes a particular bit sequence to enable detection by the OFDM receiver 308. In an illustrative example, the preamble portion 340 includes a bit sequence based on an on-off keying modulation of an OFDM waveform (e.g., multicarrier on-off keying) and includes at least one of an alternating bit pattern (e.g., alternating 0's and 1's) or a “maximum length sequence.”

In a first implementation, the preamble generator 312 is configured to include a maximum length sequence (MLS) 314 in the preamble portion 340. A maximum length sequence is a pseudorandom binary sequence that has length 2ⁿ−1 (n is a positive integer greater than 2). A maximum length sequence, when repeated, reproduces every binary sequence of length n other than the all-zeros sequence. As illustrative, non-limiting examples, an MLS for n=3 is [0,1,0,0,1,1,1] and an MLS for n=4 is [0,1,0,0,0,1,1,1,1,0,1,0,1,1,0]. In some implementations, the preamble generator 312 appends a “0” value to the MLS 314 so that the preamble portion 340 includes an even number of bits and equal numbers of 0's and 1's (e.g., to generate the sequences [0,1,0,0,1,1,1,0] or [0,1,0,0,0,1,1,1,1,0,1,0,1,1,0,0] in the above examples).

In some implementations, the preamble generator 312 includes a linear feedback shift register circuit (LFSR) 318 that is configured to generate the MLS 314. In other implementations, the MLS 314 is retrieved from a memory of the preamble generator 312 as a sequence of bits rather than generated by a LFSR. The MLS 314 may provide stronger packet detection than certain other bit sequences. For example, a relatively large correlation value may result when the MLS 314 is compared to a matching bit sequence and a relatively small correlation value may result when the MLS 314 is compared to a random bit sequence (e.g., noise). The MLS 314 may also provide stronger symbol timing correction as compared to certain other bit sequences because of the presence of bit sequences of various lengths (e.g., including strings of sequential 1's and sequential 0's of various lengths).

In a second implementation, the preamble generator 312 is configured to include an alternating bit pattern 316, such a pattern of alternating 1's and 0's (e.g., 010101 . . . or 101010 . . . ), in the preamble portion 340. The alternating bit pattern 316 may also provide stronger packet detection than certain other bit sequences, although the MLS 314 may enable more accurate symbol timing correction than the alternating bit pattern 316.

In a third implementation, the preamble generator 312 is configured to include a combination of the alternating bit pattern 316 and the MLS 314. For example, the preamble generator 312 may include the alternating bit pattern 316 followed by the MLS 314 in the preamble portion 340. The alternating bit pattern 316 may provide relatively strong support for automatic gain control at the OFDM receiver 308, and the MLS 314 provides relatively strong packet detection and symbol timing correction.

The OFDM transmitter 302 is configured to transmit the message 310 to the OFDM receiver 308 via one or more antennas 304. The message 310 includes the preamble portion 340 that includes a bit sequence (e.g., at least one of the alternating bit pattern 316 or the MLS 314) represented by on-off keying of an OFDM waveform (e.g., multicarrier on-off keying). The message 310 also includes a data portion 342. In some implementations, the message 310 may have a shorter preamble bit duration as compared to a data bit duration, such as described with reference to FIGS. 1-2. However, in other implementations the bits in the preamble portion 340 have a preamble bit duration that is the same as, or is greater than, a data bit duration of the bits in the data portion 342.

The OFDM receiver 308 includes one or more antennas 306, on-off keying circuit 330 and a preamble detector 332. The on-off keying circuit 330 is configured to extract data from an ODFM waveform that has been modulated using on-off keying (e.g., to extract data from multicarrier on-off keying). The preamble detector 332 is configured to detect messages via detection of a preamble bit sequence. For example, the preamble detector 332 may include the MLS 314, the alternating bit pattern 316, the LFSR 338, or a combination thereof, to generate a reference signal for preamble detection. The preamble detector 332 may perform a cross-correlation of a received sequence of samples from a signal received via the one or more antennas 306 to the reference signal for preamble detection, such as described with reference to the packet detector 160 of FIG. 1. The preamble detector 332 may also perform other operations based on the received sequence, such as automatic gain control and symbol timing correction, as illustrative, non-limiting examples.

In conjunction with various aspect of FIGS. 1-3, a wakeup message preamble is disclosed that is compatible with the wakeup receiver (e.g., the wakeup receiver 108) and that is consistent with the design of the data field (e.g., the data portion 194). To illustrate, if the wakeup receiver is configured to use on-off keying of OFDM (OFDM/OOK) for the data bits, the wakeup receiver is also configured to use OFDM/OOK for the preamble bits. Although referred to as on-off keying of OFDM, the on-off keying may also be referred to as multicarrier on-off keying (MC-OOK). Two design parameters of the message preamble that may be implemented are the bit sequence and the bit duration of the preamble bits.

A number of possible preamble bit sequences can be used, including a MLS sequence that provides both good packet detection and symbol timing correction (e.g., the MLS 314); alternating ones and zeros that provides good packet detection and fair symbol timing correction (e.g., the alternating bit pattern 316), or a combination such as alternating ones and zeros followed by a MLS to provide good support for automatic gain control (by the alternating pattern), and good packet detection and symbol timing correction (by the MLS).

In various implementations, after encoding of data bits (e.g., Manchester encoding or forward error correction (FEC) encoding, as non-limiting examples), the resulting code bits are the same duration as an OFDM symbol duration (e.g., 4 μs). Although a straightforward selection of a preamble bit duration is by matching the data bit duration, various benefits may result from selection of a preamble bit duration that differs from the data bit duration. For example, packet detection probability may be improved in an adaptive white Gaussian noise (AWGN) channel when the preamble bit duration is shorter than the data bit duration because a shorter preamble bit duration allows for a longer preamble bit sequence and therefore improved preamble bit sequence structure (e.g., longer MLS). For example, longer MLS sequences have improved autocorrelation as compared to shorter MLS sequences. Also, shorter preamble bit duration and longer preamble bit sequence enables improved symbol timing recovery due to a longer preamble bit sequence and improved timing resolution resulting from shorter-duration preamble bits.

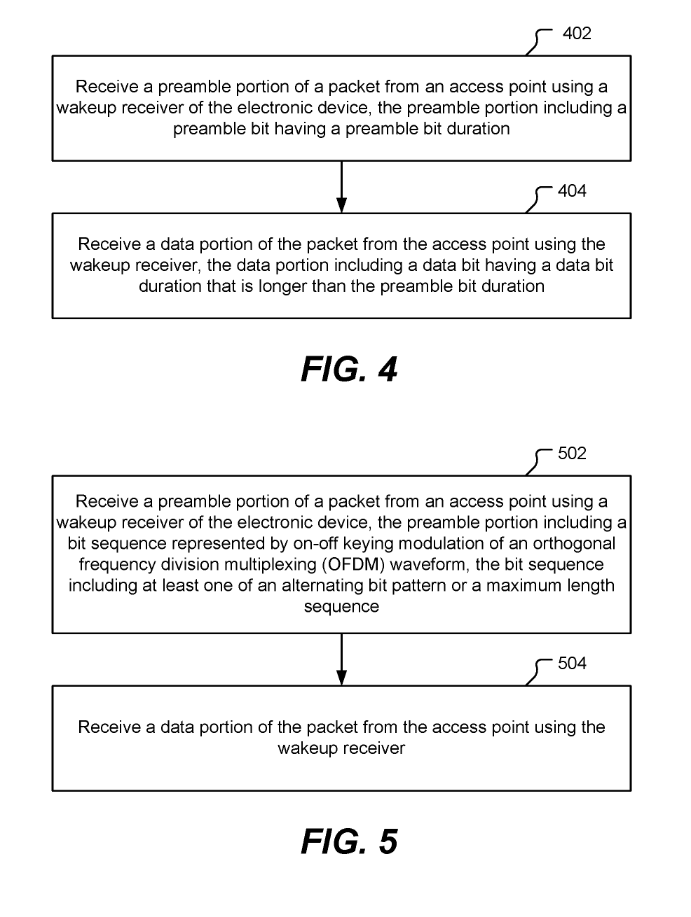

Referring to FIG. 4, an illustrative example of a method of operation of an electronic device is depicted and generally designated 400. In a particular example, the method 400 is performed by the electronic device 104 of FIG. 1, such as using the wakeup receiver 108 of FIG. 1, the OFDM receiver 308 of FIG. 3, or a combination thereof.

The method 400 includes receiving a preamble portion of a packet from an access point using a wakeup receiver of the electronic device, at 402. The preamble portion includes a preamble bit having a preamble bit duration. The method 400 includes also includes receiving a data portion of the packet from the access point using the wakeup receiver, at 404. The data portion includes a data bit having a data bit duration that is longer than the preamble bit duration. For example, the packet may correspond to the message 116 having the preamble bit duration 162 and the data bit duration 164. The method 400 may also include, in response to receiving the packet, activating a modem of the electronic device. For example, the electronic device 104 may activate the Wi-Fi modem 112 in response to receiving the message 116.

The preamble bit duration may correspond to a first length of time of transmission of each of the preamble bits in the preamble portion, and the data bit duration may correspond to a second length of time of transmission of each of the data bits in the data portion.

In some implementations, the data bit duration is substantially equal to twice the preamble bit duration, such as depicted in the first example 202 of FIG. 2. In some implementations, the data bit duration is substantially equal to four times the preamble bit duration, such as depicted in the second example 204 of FIG. 2.

The packet may be received at the wakeup receiver via an orthogonal frequency-division multiplexing (OFDM) signal. The OFDM signal includes symbols having a symbol duration (e.g., the OFDM symbol duration 210), and the symbol duration may be substantially equal to an integer multiple of the preamble bit duration (e.g., a multiple of two as in the first example 202, a multiple of four as in the second example 204, as non-limiting examples).

The symbols may be generated via an on-off keying modulation scheme. For example, the preamble portion may include a bit sequence based on an on-off keying modulation of an orthogonal frequency division multiplexing (OFDM) waveform (e.g., multicarrier on-off keying), the bit sequence including at least one of an alternating bit pattern or a maximum length sequence, the maximum length sequence corresponding to a pseudorandom binary sequence that has length 2ⁿ−1 and that, when repeated, reproduces every binary sequence of length n, other than the all-zeros sequence, wherein n is a positive integer greater than 2, such as the preamble portion 340 of FIG. 3.

Referring to FIG. 5, an illustrative example of a method of operation of an electronic device is depicted and generally designated 500. In a particular example, the method 500 is performed by the electronic device 104 of FIG. 1, such as using the wakeup receiver 108 of FIG. 1, the OFDM receiver 308 of FIG. 3, or a combination thereof.

The method 500 includes receiving a preamble portion of a packet from an access point using a wakeup receiver of the electronic device, the preamble portion including a bit sequence represented by on-off keying modulation of an orthogonal frequency division multiplexing (OFDM) waveform (e.g., multicarrier on-off keying), the bit sequence including at least one of an alternating bit pattern or a maximum length sequence, at 502 The method 500 also includes receiving a data portion of the packet from the access point using the wakeup receiver, at 504. For example, the packet may correspond to the message 310 of FIG. 3.

The maximum length sequence (e.g., that may be included in the received preamble portion, at 502) may correspond to a binary sequence that has length 2ⁿ−1 and that, when repeated, reproduces every binary sequence of length n, other than the all-zeros sequence of length n, where n is a positive integer greater than 2, such as the MLS 314 of FIG. 3. Each bit of the bit sequence has a preamble bit duration (e.g., the preamble bit duration 162), and the data portion includes a data bit having a data bit duration (e.g., the data bit duration 164) that is longer than the preamble bit duration.

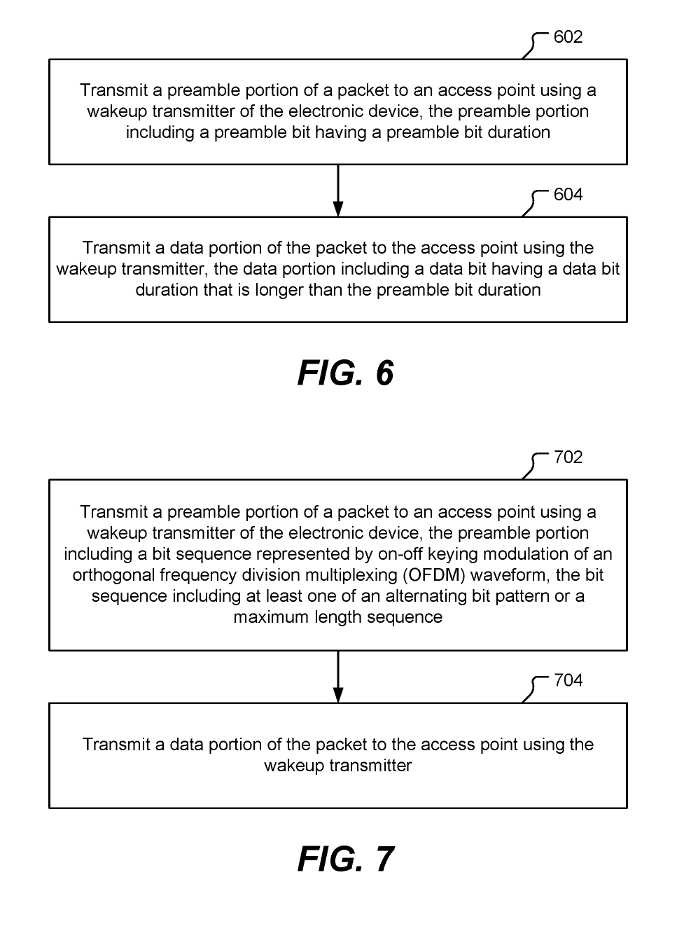

Referring to FIG. 6, an illustrative example of a method of operation of an electronic device is depicted and generally designated 600. In a particular example, the method 600 is performed by the electronic device 104 of FIG. 1, such as using the wakeup transmitter 109 of FIG. 1, the OFDM transmitter 302 of FIG. 3, or a combination thereof.

The method 600 includes transmitting a preamble portion of a packet to an access point using a transmitter of the electronic device, the preamble portion including a preamble bit having a preamble bit duration, at 602. The method 600 also includes transmitting a data portion of the packet to the access point using the transmitter of the electronic device, the data portion including a data bit having a data bit duration that is longer than the preamble bit duration, at 604. For example, the packet may correspond to the message 116.

Referring to FIG. 7, an illustrative example of a method of operation of an electronic device is depicted and generally designated 700. In a particular example, the method 700 is performed by the electronic device 104 of FIG. 1, such as using the OFDM transmitter 302 of FIG. 3.

The method 700 includes transmitting a preamble portion of a packet to an access point using a transmitter of the electronic device, the preamble portion including a bit sequence represented by on-off keying modulation of an orthogonal frequency division multiplexing (OFDM) waveform (e.g., multicarrier on-off keying), the bit sequence including at least one of an alternating bit pattern or a maximum length sequence, at 702. The method 700 also includes transmitting a data portion of the packet to the access point using the transmitter, at 704. For example, the packet may correspond to the message 310 of FIG. 3.

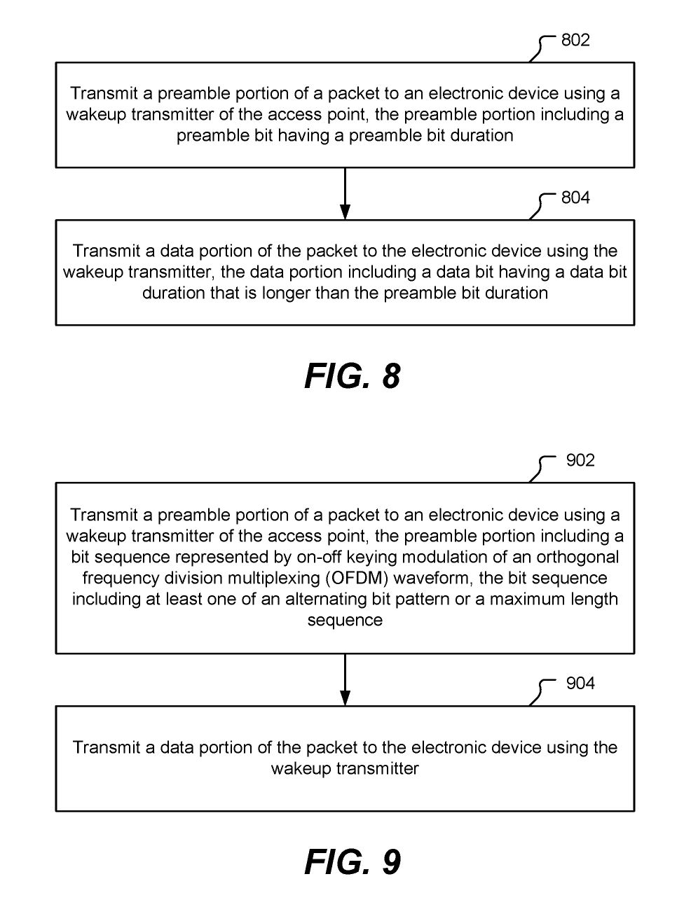

Referring to FIG. 8, an illustrative example of a method of operation of an access point is depicted and generally designated 800. In a particular example, the method 800 is performed by the access point 134 of FIG. 1, such as using the wakeup transmitter 136 of FIG. 1, the OFDM transmitter 302 of FIG. 3, or a combination thereof.

The method 800 includes transmitting a preamble portion of a packet to an electronic device using a transmitter of the access point, the preamble portion including a preamble bit having a preamble bit duration, at 802. The method 800 also includes transmitting a data portion of the packet to the electronic device using the transmitter, the data portion including a data bit having a data bit duration that is longer than the preamble bit duration, at 804. For example, the packet may correspond to the message 116.

Referring to FIG. 9, an illustrative example of a method of operation of an access point is depicted and generally designated 900. In a particular example, the method 900 is performed by the access point 134 of FIG. 1, such as using the wakeup transmitter 136 of FIG. 1, the OFDM transmitter 302 of FIG. 3, or a combination thereof.

The method 900 includes transmitting a preamble portion of a packet to an electronic device using a transmitter of the access point, the preamble portion including a bit sequence represented by on-off keying modulation of an orthogonal frequency division multiplexing (OFDM) waveform (e.g., multicarrier on-off keying), the bit sequence including at least one of an alternating bit pattern or a maximum length sequence, at 902. The method 900 also includes transmitting a data portion of the packet to the electronic device using the transmitter, at 902. For example, the packet may correspond to the message 310 of FIG. 3.

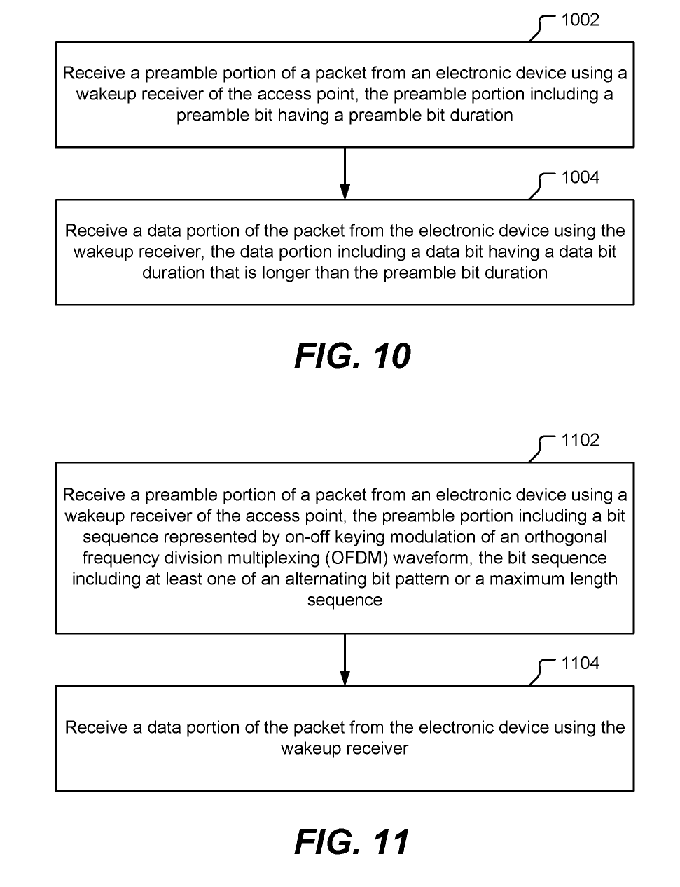

Referring to FIG. 10, an illustrative example of a method of operation of an access point is depicted and generally designated 1000. In a particular example, the method 1000 is performed by the access point 134 of FIG. 1, such as using the wakeup receiver 137 of FIG. 1, the OFDM receiver 308 of FIG. 3, or a combination thereof.

The method 1000 includes receiving a preamble portion of a packet from an electronic device using a receiver of the access point, the preamble portion including a preamble bit having a preamble bit duration, at 1002. The method 1000 also includes receiving a data portion of the packet from the electronic device using the receiver, the data portion including a data bit having a data bit duration that is longer than the preamble bit duration, at 1004. For example, the packet may correspond to the message 116.

Referring to FIG. 11, an illustrative example of a method of operation of an access point is depicted and generally designated 1100. In a particular example, the method 1100 is performed by the access point 134 of FIG. 1, such as using the wakeup receiver 137 of FIG. 1, the OFDM receiver 308 of FIG. 3, or a combination thereof.

The method 1100 includes receiving a preamble portion of a packet from an electronic device using a receiver of the access point, the preamble portion including a bit sequence represented by on-off keying modulation of an orthogonal frequency division multiplexing (OFDM) waveform (e.g., multicarrier on-off keying), the bit sequence including at least one of an alternating bit pattern or a maximum length sequence, at 1102. The method 1102 also includes receiving a data portion of the packet from the electronic device using the receiver, at 1104. For example, the packet may correspond to the message 310 of FIG. 3.

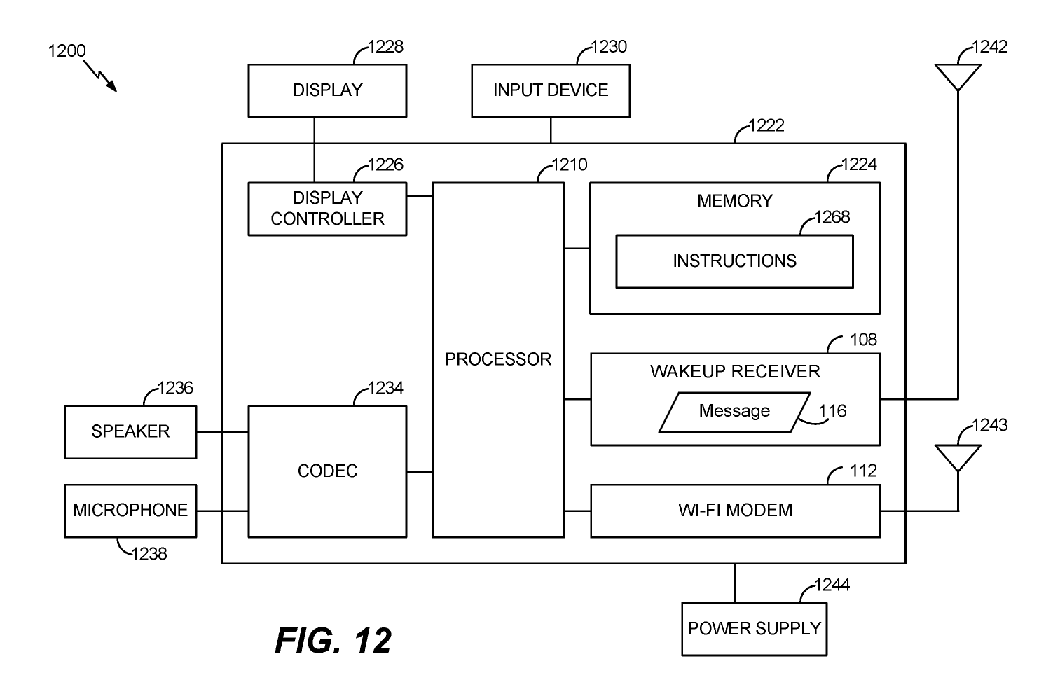

Referring to FIG. 12, a block diagram of a particular illustrative example of an electronic device is depicted and generally designated 1200. The electronic device 1200 may correspond to a mobile device (e.g., a cellular phone), a computer (e.g., a server, a laptop computer, a tablet computer, or a desktop computer), an access point, a base station, a wearable electronic device (e.g., a personal camera, a head-mounted display, or a watch), a vehicle control system or console, an autonomous vehicle (e.g., a robotic car or a drone), a home appliance, a set top box, an entertainment device, a navigation device, a personal digital assistant (PDA), a television, a monitor, a tuner, a radio (e.g., a satellite radio), a music player (e.g., a digital music player or a portable music player), a video player (e.g., a digital video player, such as a digital video disc (DVD) player or a portable digital video player), a robot, a healthcare device, another electronic device, or a combination thereof.

In some implementations, one or more aspects of the electronic device 1200 of FIG. 12 correspond to the electronic device 104 of FIG. 1. Alternatively, or in addition, one or more aspects of the electronic device 1200 of FIG. 12 may correspond to the access point 134 of FIG. 1. One or more aspects of the electronic device may correspond to the OFDM transmitter 302 of FIG. 3, the OFDM receiver 308 of FIG. 3, or a combination thereof.

The electronic device 1200 includes one or more processors, such as a processor 1210. The processor 1210 may include a digital signal processor (DSP), a central processing unit (CPU), a graphics processing unit (GPU), another processing device, or a combination thereof.

The electronic device 1200 may further include one or more memories, such as the memory 1224. The memory 1224 may be coupled to the processor 1210. The memory 1224 may include random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), one or more registers, a hard disk, a removable disk, a compact disc read-only memory (CD-ROM), another memory device, or a combination thereof.

The memory 1224 may store instructions 1268. The instructions 1268 are executable by the processor 1210 to perform one or more operations described herein.

A coder/decoder (CODEC) 1234 can also be coupled to the processor 1210. The CODEC 1234 may be coupled to one or more microphones, such as a microphone 1238. FIG. 12 also shows a display controller 1226 that is coupled to the processor 1210 and to a display 1228. A speaker 1236 may be coupled to the CODEC 1234.

The electronic device 1200 may further include the wakeup receiver 108 and the Wi-Fi modem 112. An antenna 1242 may be coupled to the wakeup receiver 108, and an antenna 1243 may be coupled to the Wi-Fi modem 112. In an alternative implementation, the wakeup receiver 108 and the Wi-Fi modem 112 may be coupled to a common antenna.

In a particular example, the processor 1210, the memory 1224, the display controller 1226, the CODEC 1234, the wakeup receiver 108, and the Wi-Fi modem 112 are included in or attached to a system-on-chip (SoC) device 1222. Further, an input device 1230 and a power supply 1244 may be coupled to the SoC device 1222. Moreover, in a particular example, as illustrated in FIG. 12, the display 1228, the input device 1230, the speaker 1236, the microphone 1238, the antenna 1242, and the power supply 1244 are external to the SoC device 1222. However, each of the display 1228, the input device 1230, the speaker 1236, the microphone 1238, the antenna 1242, and the power supply 1244 can be coupled to a component of the SoC device 1222, such as to an interface or to a controller.

Although examples described with reference to FIGS. 1-12 are described with reference stations and access points, it should be understood that low-power messaging, preamble generation, and preamble detection as described herein may also be used in other implementations, such as station-to-station communications, or peer-to-peer wireless networking technologies, as illustrative, non-limiting examples.

The foregoing disclosed devices and functionalities may be designed and represented using computer files (e.g. RTL, GDSII, GERBER, etc.). The computer files may be stored on computer-readable media. Some or all such files may be provided to fabrication handlers who fabricate devices based on such files. Resulting products include wafers that are then cut into die and packaged into integrated circuits (or “chips”). The chips are then employed in electronic devices, such as the electronic device 1200 of FIG. 12.

As used herein, “coupled” may include communicatively coupled, electrically coupled, magnetically coupled, physically coupled, optically coupled, and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc.

The various illustrative logical blocks, configurations, modules, circuits, and algorithm steps described in connection with the examples disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

One or more operations of a method or algorithm described herein may be embodied directly in hardware, in a software module executed by a processor, or in a combination of the two. For example, one or more operations of one or more of the methods 400-1100 may be initiated, controlled, or performed by a field-programmable gate array (FPGA) device, an application-specific integrated circuit (ASIC), a processing unit such as a central processing unit (CPU), a digital signal processor (DSP), a controller, another hardware device, a firmware device, or a combination thereof. A software module may reside in random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transitory storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed examples is provided to enable a person skilled in the art to make or use the disclosed examples. Various modifications to these examples will be readily apparent to those skilled in the art, and the principles defined herein may be applied to other examples without departing from the scope of the disclosure. Thus, the present disclosure is not intended to be limited to the examples shown herein but is to be accorded the widest scope possible consistent with the principles and novel features as defined by the following claims.

What is claimed is:

1. A method of operation of an electronic device, the method comprising:
receiving a preamble portion of a packet from an access point using a wakeup receiver of the electronic device, the preamble portion including a preamble bit having a preamble bit duration; and
receiving a data portion of the packet from the access point using the wakeup receiver, the data portion including a data bit having a data bit duration that is longer than the preamble bit duration.

2. The method of claim 1, wherein the preamble bit duration corresponds to a first length of time of transmission of each preamble bit in the preamble portion, and the data bit duration corresponds to a second length of time of transmission of each data bit in the data portion.

3. The method of claim 1, further comprising in response to receiving the packet, activating a modem of the electronic device.

4. The method of claim 1, wherein the data bit duration is substantially equal to twice the preamble bit duration.

5. The method of claim 1, wherein the data bit duration is substantially equal to four times the preamble bit duration.

6. The method of claim 1, wherein the packet is received at the wakeup receiver via an orthogonal frequency-division multiplexing (OFDM) signal, the OFDM signal including symbols having a symbol duration, and wherein the symbol duration is substantially equal to an integer multiple of the preamble bit duration.

7. The method of claim 6, wherein the symbols are generated via an on-off keying modulation scheme.

8. The method of claim 1, wherein the preamble portion includes a bit sequence based on an on-off keying modulation of an orthogonal frequency division multiplexing (OFDM) waveform, the bit sequence including at least one of an alternating bit pattern or a maximum length sequence.

9. The method of claim 8, wherein the maximum length sequence corresponds to a pseudorandom binary sequence that has length 2ⁿ−1 and wherein the maximum length sequence, when repeated, reproduces every binary sequence of length n, other than the all-zeros sequence, wherein n is a positive integer greater than 2.

10. The method of claim 1, further comprising performing symbol timing correction based on the preamble portion of the packet.

11. An electronic device comprising:
a wakeup receiver configured to receive a preamble portion and a data portion of a packet from an access point via a first channel, the preamble portion including a preamble bit having a preamble bit duration and the data portion including a data bit having a data bit duration that is longer than the preamble bit duration; and
a modem configured to communicate with the access point using a second channel.

12. The electronic device of claim 11, wherein the preamble bit duration corresponds to a first length of time of transmission of each preamble bit in the preamble portion, and the data bit duration corresponds to a second length of time of transmission of each data bit in the data portion.

13. The electronic device of claim 11, further comprising a processor configured to activate the modem responsive to receiving the packet at the wakeup receiver.

14. The electronic device of claim 11, wherein the data bit duration is substantially equal to twice the preamble bit duration.

15. The electronic device of claim 11, wherein the preamble portion includes a bit sequence based on an on-off keying modulation of an orthogonal frequency division multiplexing (OFDM) waveform, the bit sequence including at least one of an alternating bit pattern or a maximum length sequence.

16. The electronic device of claim 15, wherein the maximum length sequence corresponds to a pseudorandom binary sequence that has length 2ⁿ−1 and wherein the maximum length sequence, when repeated, reproduces every binary sequence of length n, other than the all-zeros sequence, wherein n is a positive integer greater than 2.

17. A method of operation of an access point, the method comprising:
transmitting a preamble portion of a packet to an electronic device using a transmitter of the access point, the preamble portion including a preamble bit having a preamble bit duration; and
transmitting a data portion of the packet to the electronic device using the transmitter, the data portion including a data bit having a data bit duration that is longer than the preamble bit duration.

18. The method of claim 17, wherein the preamble bit duration corresponds to a first length of time of transmission of the preamble bit, and the data bit duration corresponds to a second length of time of transmission of the data bit.

19. The method of claim 17, wherein the data bit duration is substantially equal to twice the preamble bit duration.

20. The method of claim 17, wherein the data bit duration is substantially equal to four times the preamble bit duration.

21. The method of claim 17, wherein the packet is transmitted from the transmitter via an orthogonal frequency-division multiplexing (OFDM) signal, the OFDM signal including symbols having a symbol duration.

22. The method of claim 21, wherein the symbols are generated via an on-off keying modulation scheme.

23. The method of claim 17, wherein the preamble portion includes a bit sequence based on an on-off keying modulation of an orthogonal frequency division multiplexing (OFDM) waveform, the bit sequence including at least one of an alternating bit pattern or a maximum length sequence.

24. The method of claim 23, wherein the maximum length sequence corresponds to a pseudorandom binary sequence that has length 2ⁿ−1 and wherein the maximum length sequence, when repeated, reproduces every binary sequence of length n, other than the all-zeros sequence, wherein n is a positive integer greater than 2.

25. An apparatus comprising:
a transmitter configured to transmit a preamble portion and a data portion of a packet to an electronic device via a first channel, the preamble portion including a preamble bit having a preamble bit duration and the data portion including a data bit having a data bit duration that is longer than the preamble bit duration; and
a modem configured to communicate with the electronic device using a second channel.

26. The apparatus of claim 25, wherein the preamble bit duration corresponds to a first length of time of transmission of the preamble bit, and the data bit duration corresponds to a second length of time of transmission of the data bit.

27. The apparatus of claim 25, wherein the data bit duration is substantially equal to twice the preamble bit duration.

28. The apparatus of claim 25, wherein the packet is transmitted via an orthogonal frequency-division multiplexing (OFDM) signal, the OFDM signal including symbols having a symbol duration, wherein the symbol duration is substantially equal to an integer multiple of the preamble bit duration, and wherein the symbols are generated via an on-off keying modulation scheme.

29. The apparatus of claim 25, wherein the preamble portion includes a bit sequence based on an on-off keying modulation of an orthogonal frequency division multiplexing (OFDM) waveform, the bit sequence including at least one of an alternating bit pattern or a maximum length sequence.

30. The apparatus of claim 29, wherein the maximum length sequence corresponds to a pseudorandom binary sequence that has length 2ⁿ−1 and wherein the maximum length sequence, when repeated, reproduces every binary sequence of length n, other than the all-zeros sequence, wherein n is a positive integer greater than 2.
